(19) United States
(12) Patent Application Publication
(10) Pub. No.: US 2015/0059326 A1
(43) Pub. Date: Mar. 5, 2015

(54) INTERNALLY DRAINED HYDRAULIC MOTOR

(71) Applicant: HYDRO LEDUC, Azerailles (FR)

(72) Inventor: François Porel, Sainte Pole (FR)

(21) Appl. No.: 14/385,684

(22) PCT Filed: Mar. 8, 2013
(86) PCT No.: PCT/FR2013/050499

§ 371 Date: Sep. 16, 2014

(30) Foreign Application Priority Data
Mar. 19, 2012 (FR) 1252426

(51) Int. Cl. F15B 11/02; F15B 11/15

(52) U.S. Cl. CPC F15B 11/02; F15B 11/15; F15B 2211/30505
USPC 60/413

(57) ABSTRACT

A hydraulic motor that can be operated in both directions, the hydraulic motor comprising two two-way hydraulic ports each of which can be connected, selectively depending on the direction of rotation in which the motor is to be actuated, either to a source of pressurized liquid or to a device for collecting the liquid at a lower pressure, the hydraulic motor comprising a drain port communicating with an interior space of the motor case, which comprises:
an intermediate pipe into which the drain pipe of the case opens,
a first non-return valve positioned between the intermediate pipe and a first two-way hydraulic port and able to open toward the first two-way hydraulic port; and
a second non-return valve positioned between the intermediate pipe and a second two-way hydraulic port and able to open toward the second two-way hydraulic port.

The present invention relates to an improvement made to a hydraulic motor.

It is known practice to equip a hydraulic motor with one or two drain ports by means of which the internal leaks that arise inside said motor are removed to outside same. This arrangement has the disadvantage of entailing the installation of a drain pipe in addition to the pipe that feeds the motor with pressurized liquid from the pump and the return-to-tank pipe.

With reference to FIG. 4, it may be seen that the drive motor M, which may be an electric motor, an internal combustion engine or similar, drives a pump P, the high-pressure outlet of which is connected to a distributor D that allows several types of hydraulic connections to be made selectively between the outlet of the pump P and two feed lines A and B connected to the hydraulic motor H. In the neutral position depicted, the distributor D connects the two lines A and B to the tank 99. There is therefore no feed to the hydraulic motor H. The other two positions of the distributor D make it possible:
either to connect pipe A to the pump P and pipe B to the tank 99, in order to make the hydraulic motor H turn in one direction,
or to connect pipe A to the tank 99 and pipe B to the pump P, to make the hydraulic motor H turn in the other direction.

A drain pipe 98 connects the case of the hydraulic motor H to the tank 99. In some cases, particularly when the motor needs to be the element that drives tools fitted to assemblies that are to be connected to the arms of public works vehicles, for example a truck, the position in which it is situated may make installing the drain pipe 98 very difficult. In such situations, it is often only the lines A and B that are provided on the vehicle.

It is an object of the present invention to eliminate this disadvantage.

According to one embodiment, the invention provides a hydraulic motor that can be operated in both directions, the hydraulic motor comprising two two-way hydraulic ports each of which can be connected, selectively depending on the direction of rotation in which the motor is to be actuated, either to a source of pressurized liquid in order to act as a feed port for the hydraulic motor, or to a device for collecting the liquid at a lower pressure in order to act as a hydraulic motor return port, the hydraulic motor comprising a drain port communicating with an interior space of the motor case, characterized in that it comprises:
an intermediate pipe into which the drain port of the case opens,
a first non-return valve positioned between the intermediate pipe and a first two-way hydraulic port and able to open under the effect of a positive pressure differential between the intermediate pipe and the first two-way hydraulic port; and
a second non-return valve positioned between the intermediate pipe and a second two-way hydraulic port and able to open under the effect of a positive pressure differential between the intermediate pipe and the second two-way hydraulic port.

Such an arrangement allows liquid originating from the internal leaks inside the motor to be removed from the case through that one of the two non-return valves that is connected to the motor return port. Thus, the return pipe of the motor also acts as a drain pipe, making it possible to dispense with the separate drain pipes customarily used.

Depending on the embodiment, the invention also comprises all or some of the following arrangements.

According to one embodiment, the intermediate pipe communicates between the two non-return valves with a accumulator charged with absorbing pressure spikes each time the direction of the fluid and, as a result, the direction of rotation of the hydraulic motor, is reversed.

According to one embodiment, the hydraulic motor further comprises an output shaft accessible from outside the case and, inside the case:
a plate secured to the motor shaft and comprising a plurality of spherical housings,
a barrel mounted so as to be able to rotate on a pivot the axis of which makes an angle with the axis of the motor shaft,
a plurality of pistons sliding in cylindrical bores formed axially in the barrel, each piston having a spherical head housed in one of the spherical housings of the plate, and
a port plate against which a rear face of the barrel rests slidingly.

According to one embodiment, the case comprises a cylinder block on which the two two-way hydraulic ports of the motor are positioned.

According to one embodiment, the intermediate pipe and the two non-return valves are positioned in the cylinder block.

According to one embodiment, the two-way hydraulic ports comprise ports formed in the cylinder block.

According to one embodiment, the cylinder block comprises the accumulator charged with absorbing pressure spikes and connected to the intermediate pipe.

According to one embodiment, the drain port extends through the cylinder block to connect the intermediate pipe to a region of the case that is situated behind the port plate.

The invention will be better understood, and further objects, details, features and advantages thereof will become more clearly apparent during the course of the following description of one particular embodiment of the invention which is given solely by way of non-limiting illustration with reference to the attached drawings. In these drawings:

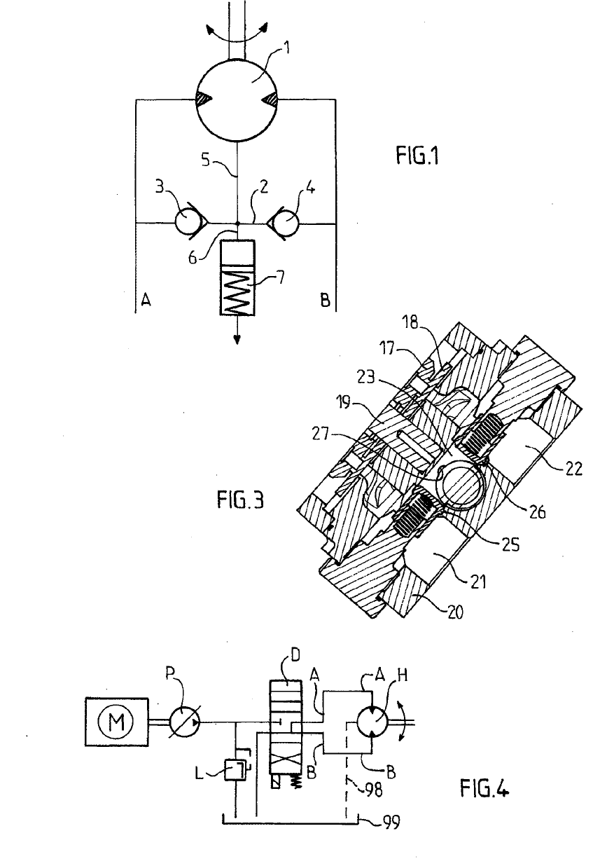

FIG. 1 is a block diagram of a hydraulic motor according to one embodiment of the invention.

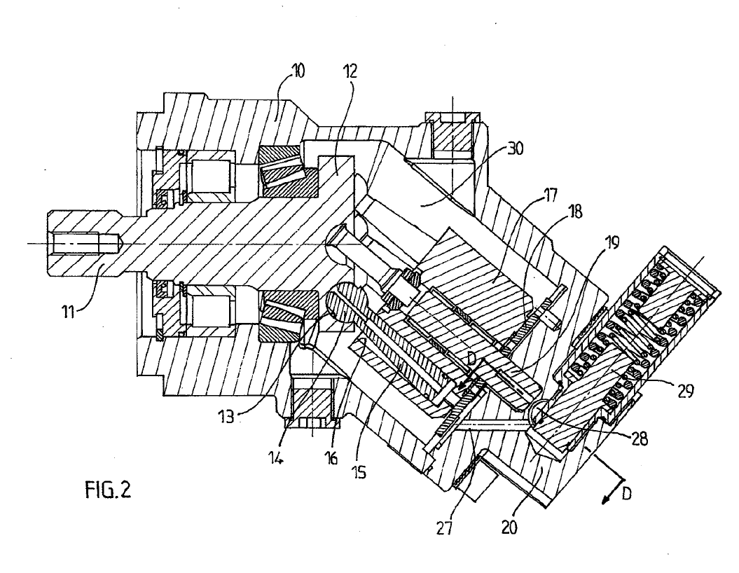

FIG. 2 is a view in longitudinal section of one embodiment of the hydraulic motor of FIG. 1.

FIG. 3 is a view in detail in section on D-D of FIG. 2.

FIG. 4 is a block diagram of a hydraulic system according to the prior art.

FIG. 1 depicts a hydraulic motor 1 according to the invention which can be arranged in the hydraulic system of FIG. 4 in place of the motor H of FIG. 4.

With reference to FIG. 1, it may be seen that the two pipes A and B are connected to one another by an intermediate pipe 2 which comprises two non-return valves 3 and 4 and which is connected to the case of the hydraulic motor 1 by a pipe 5 positioned between the two valves 3 and 4.

The way in which this device works is as follows.

When pipe A is the feed pipe and pipe B is the return pipe, the valve 3 is kept closed by the high pressure whereas the valve 4 is subjected only to the return-to-tank pressure.

Internal leaks arising inside the motor 1 are collected by the pipe 5. As the pressure of these internal leaks increases, the liquid in the pipe 5 opens the valve 4 and reaches the return-to-tank pipe B.

Thus there is no longer any need to provide a drain for the motor 1 via external lines as is currently performed, this drainage being performed by means internal to the motor 1.

For preference, the pipe 6, positioned between the two valves 3 and 4, connects the pipe 2 to an accumulator 7 capable of absorbing the pressure spikes when the direction of rotation of the hydraulic motor changes. This arrangement makes it possible to absorb the pressure spikes likely to occur when the direction of rotation of the motor suddenly changes, i.e. when the high-pressure and low-pressure sides suddenly swop.

FIGS. 2 and 3 illustrate one embodiment of the invention. Positioned inside a case 10 is a shaft bearing a plate 12 comprising a plurality of spherical housings 13 in which are accommodated the spherical heads 14 of pistons 15 which slide in the cylinders 16 formed in a barrel 17. The barrel 17 is pivot-mounted on a pivot 19 the axis of which makes an angle with the axis of the shaft 1. The rear face of the barrel 17 rests against a port plate 18. This type of discontinuous-axis hydraulic motor is known.

According to one embodiment of the invention, the cylinder block 20 of the case 10 comprises the means described in conjunction with FIG. 1.

Pipe A in FIG. 1 reaches the motor via the port 21 and pipe B via the port 22 (FIG. 3). The pipe 23, which corresponds to pipe 2 in FIG. 1, comprises two non-return valves 25 and 26 which correspond to the valves 3 and 4 in FIG. 1. The pipe 27, which corresponds to the pipe 5, arrives between these two valves 25 and 26.

A passage 28, (FIG. 2), corresponding to the pipe 6 in FIG. 1, places the pipe 23 in communication with an accumulator capable of absorbing pressure spikes when the direction of rotation of the hydraulic motor changes. The accumulator 29 is formed of a piston driven by compression springs, but this choice is non-limiting. In particular, the accumulator 29 makes it possible to prevent the pressure exceeding the sealing limit of the case 10 frontal gasket when the direction of rotation of the motor suddenly reverses.

The operation is that described in conjunction with FIG. 1. When the motor is fed with pressurized hydraulic liquid, leaks occur between the rear face of the barrel 17 and the port plate 18. These leaks cause an increase in the pressure of the liquid located in the volume 30 of the case 10 in which the barrel 17 is positioned. As the pipe 27 is in communication with said volume 30 of the case 10, this pressure acts on the two valves 25 and 26. That one of the two valves 25 and 26 that corresponds to the feed port of the motor 10 (dependent on the direction of feed of the motor) is subjected to a high pressure on the exterior surface thereof so that it remains in the closed state. Conversely, that one of the two valves 25 and 26 that corresponds to the return port of the motor 10 opens because of the pressure differential between the pipe 23 and the low-pressure return-to-tank circuit. As a result, liquid generated from internal leaks inside the motor is removed by that one of the two pipes A and B that is connected to the tank.

Although the invention has been described in conjunction with just one particular embodiment, it is quite obvious that it is not in any way restricted thereto and that it comprises all technical equivalents of the means described and combinations thereof where these fall within the scope of the invention.

The use of the verbs “comprise”, “include” or “have” and the conjugated forms thereof does not exclude the presence of elements or steps other than those listed in a claim. The use of the indefinite article “a/an” or “one” for an element does not, unless otherwise mentioned, exclude there being a plurality of such elements present.

In the claims, any reference symbol between parentheses must not be interpreted as a limitation on the claim.

1. A hydraulic motor that can be operated in both directions, the hydraulic motor comprising two two-way hydraulic ports each of which can be connected, selectively depending on the direction of rotation in which the motor is to be actuated, either to a source of pressurized liquid in order to act as a feed port for the hydraulic motor, or to a device for collecting the liquid at a lower pressure in order to act as a hydraulic motor return port, the hydraulic motor comprising a drain port communicating with an interior space of the motor case, which comprise
an intermediate pipe into which the drain port of the case opens,
a first non-return valve positioned between the intermediate pipe and a first two-way hydraulic port and able to open under the effect of a positive pressure differential between the intermediate pipe and the first two-way hydraulic port; and
a second non-return valve positioned between the intermediate pipe and a second two-way hydraulic port and able to open under the effect of a positive pressure differential between the intermediate pipe and the second two-way hydraulic port.

2. The hydraulic motor as claimed in claim 1, wherein the intermediate pipe communicates between the two non-return valves with a pressure accumulator.

3. The hydraulic motor as claimed in claim 1, further comprising an output shaft accessible from outside the case and, inside the case:
a plate secured to the motor shaft and comprising a plurality of spherical housings,
a barrel mounted so as to be able to rotate on a pivot the axis of which makes an angle with the axis of the motor shaft,
a plurality of pistons sliding in cylindrical bores formed axially in the barrel, each piston having a spherical head housed in one of the spherical housings of the plate, and
a port plate against which a rear face of the barrel (17) rests slidingly.

4. The hydraulic motor as claimed in claim 3, wherein the case comprises a cylinder block on which the two two-way hydraulic ports of the motor are positioned.

5. The hydraulic motor as claimed in claim 4, wherein the intermediate pipe and the two non-return valves are positioned in the cylinder block.

6. The hydraulic motor as claimed in claim 4, wherein the two-way hydraulic ports comprise ports formed in the cylinder block.

7. The hydraulic motor as claimed in claim 4, in which the cylinder block comprises an accumulator capable of absorbing pressure spikes when the direction of rotation of the motor reverses, the accumulator being connected to the intermediate pipe.

8. The hydraulic motor as claimed in claim 4, in which the drain port (27) extends through the cylinder block (20) to connect the intermediate pipe (23) to a region of the case that is situated behind the port plate (18).

9. The hydraulic motor as claimed in claim 5, wherein the two-way hydraulic ports comprise ports formed in the cylinder block.

10. The hydraulic motor as claimed in claim 5, wherein the cylinder block comprises an accumulator capable of absorbing pressure spikes when the direction of rotation of the motor reverses, the accumulator being connected to the intermediate pipe.

11. The hydraulic motor as claimed in claim 6, wherein the cylinder block comprises an accumulator capable of absorbing pressure spikes when the direction of rotation of the motor reverses, the accumulator being connected to the intermediate pipe.

12. The hydraulic motor as claimed in claim 5, wherein the drain port extends through the cylinder block to connect the intermediate pipe to a region of the case that is situated behind the port plate.

13. The hydraulic motor as claimed in claim 6, wherein the drain port extends through the cylinder block to connect the intermediate pipe to a region of the case that is situated behind the port plate.

14. The hydraulic motor as claimed in claim 7, wherein the drain port extends through the cylinder block to connect the intermediate pipe to a region of the case that is situated behind the port plate.
